(19) United States
(12) Patent Application Publication
(10) Pub. No.: US 2026/0167501 A1
(43) Pub. Date: Jun. 18, 2026

(54) WATER VAPOR-MODIFIED CHEMICALLY-DERIVED CAPACITIVE CARBON, AND PREPARATION METHOD AND USE THEREOF

(71) Applicant: Beijing HCC Energy Technology Co., Ltd., Beijing (CN)

(72) Inventors: Dazhi WANG, Beijing (CN); Xiuqiang LI, Beijing (CN)

(73) Assignee: Beijing HCC Energy Technology Co., Ltd., Beijing (CN)

(21) Appl. No.: 19/420,169

(22) Filed: Dec. 15, 2025

(30) Foreign Application Priority Data
Dec. 16, 2024 (CN) 202411844420.8

(51) Int. Cl. C01B 32/354; C01B 32/348; H01G 11/34; H01G 11/86

(52) U.S. Cl. CPC C01B 32/354; C01B 32/348; H01G 11/34; H01G 11/86

(57) ABSTRACT

Provided is a method for preparing a water vapor-modified chemically-derived capacitive carbon, including: (1) using a non-high-temperature-calcined activated carbon, namely, an intermediate of a current commercial chemically-derived capacitive carbon, as a carbon material, filling the carbon material into a corundum boat, and placing the corundum boat in a tubular furnace; (2) introducing an inert gas into the tubular furnace, heating to 250° C. at a heating rate of 10° C./min to 15° C./min, switching the inert gas to water vapor with a flow rate of 0.15 L/min to 0.35 L/min, continuing heating to a temperature of 850° C. to 950° C. at the same heating rate, and holding at the temperature of 850° C. to 950° C. for a specified time; and (3) naturally cooling to 750° C., switching the water vapor to an inert gas, continuing cooling to room temperature, and taking out a resulting product to obtain the modified capacitive carbon.

### CROSS REFERENCE TO RELATED APPLICATION

This patent application claims the benefit and priority of Chinese Patent Application No. 202411844420.8 filed with the China National Intellectual Property Administration on Dec. 16, 2024, and entitled with “WATER VAPOR-MODIFIED CHEMICALLY-DERIVED CAPACITIVE CARBON, AND PREPARATION METHOD AND USE THEREOF”, the disclosure of which is incorporated by reference herein in its entirety as part of the present application.

### TECHNICAL FIELD

The present disclosure relates to the technical field of supercapacitors, and more particularly relates to a water vapor-modified chemically-derived capacitive carbon, and a preparation method and use thereof.

### BACKGROUND

Supercapacitors, known for their advantages such as high capacitance, fast charging and discharging, long lifespan, and environmental friendliness, are widely used in fields such as aerospace, marine vessels, national defense and military industry, transportation, electronic information, and instrumentation. With advancements in science and technology, applications of the supercapacitors are expanding increasingly. However, current supercapacitors perform poorly in extreme environments, such as in high humidity and high temperature, their capacity decays rapidly, and the internal resistance change rate alters significantly. Due to such a drawback, these supercapacitors fail in the “85° C./85% RH” 1,000-hour aging test, severely hindering their further applications.

A key carbon material for the supercapacitors is capacitive carbon, where a quality of the capacitive carbon directly determines capacity and stability of the supercapacitors. Currently, there are two methods for producing commercial capacitive carbon: one is the chemical method, and the other is the physical method. The chemical method adopts a chemical agent (primarily potassium hydroxide) as an activator and a carbon-containing material as a carbon source. The two materials are ground into powders, mixed, and then subjected to high-temperature activation for a certain period. The activator acts on the carbon material to allow etching, followed by post-treatment to form a porous capacitive carbon. This preparation method features high activation temperature and desirable carbon yield. The resulting capacitive carbon exhibits excellent methylene blue adsorption capacity, high iodine value, large specific surface area, and well-developed micropores. However, such a capacitive carbon has high organic and inorganic ash content. When being used as an electrode material to fabricate a capacitor, the capacitive carbon shows high initial specific capacitance, rapid capacity decay, high internal resistance change rate, and short high-temperature lifespan. The physical method adopts water vapor or carbon dioxide (primarily the water vapor) as an activator and a woody material as a carbon source. The two materials are crushed to a required particle size, fed into an activation furnace, and then subjected to high-temperature and long-duration activation with the introduction of an activation gas. Carbon reacts with the water vapor, generating carbon monoxide and carbon dioxide, which escape from the carbon to form pores. After post-treatment, a commercial physically-derived capacitive carbon is obtained. This preparation method features high activation temperature, long duration, and low carbon yield. The resulting physically-derived capacitive carbon exhibits poor methylene blue adsorption capacity, low iodine value, and small specific surface area. However, such a capacitive carbon offers good conductivity, fast dispersion, and adsorption speed, as well as low organic and inorganic ash content. When being used as an electrode material to fabricate a capacitor, the physically-derived capacitive carbon demonstrates poor capacity decay rate, low internal resistance, and long lifespan, as well as high-temperature and high-pressure stability. Therefore, this capacitive carbon can withstand the “85° C./85% RH” 1,000-h aging test. Due to the poor methylene blue adsorption capacity, low iodine value, and small specific surface area of the capacitive carbon prepared by the physical water vapor method, assembled capacitors exhibit low capacitance. For example, Japanese YP-50 coconut shell-based capacitive carbon, prepared by the physical water vapor method, achieves an initial specific capacitance of 106 F/g when being assembled into a button-type capacitor. However, current commercial petroleum coke-based capacitive carbon prepared by the chemical method shows an initial specific capacitance as high as 142 F/g, exhibiting a difference of 36 F/g. The specific capacitance of the YP-50 coconut shell-based capacitive carbon demonstrates the highest specific capacitance among commercially available physically-derived capacitive carbon on the market. The physically-derived capacitive carbon has good electrical conductivity, fast dispersion and adsorption rate, when being used as an electrode material to prepare a capacitor, the capacitor has characteristics of desirable conductivity, rapid dispersion and adsorption, low capacity decay rate, and long high-temperature lifespan. Carbon material experts worldwide have been researching ways to improve the specific capacitance of the physically-derived capacitive carbon in recent years. However, no physically-derived capacitive carbon has surpassed the YP-50 coconut shell-based capacitive carbon in specific capacitance.

In order to enhance the specific capacity of physically-derived capacitive carbon, adapt to the performance of capacitor in extreme environments, and further expand the application range of capacitor, after half a year's experimental research, the inventors have developed a process to modify the properties of chemically-derived capacitive carbon using water vapor, so that the chemically-derived capacitive carbon is endowed with the characteristics of desirable conductivity, rapid adsorption, and low agglomeration of physically-derived capacitive carbon. The capacitors made with the modified capacitive carbon exhibit the same characteristics of low decay rate and long high-temperature lifespan as those made with physically prepared capacitive carbon.

### SUMMARY

In view of this, the present disclosure provides a method for modifying chemically-derived capacitive carbon using water vapor. The activated carbon prepared by the method exhibits a large specific surface area, wide pore radius, desirable electrical conductivity, rapid adsorption, and low agglomeration, possessing characteristics identical to those of physically-derived capacitive carbon. By using capacitor electrodes made from this modified capacitive carbon, the capacitors have high specific capacity, low decay rate, and long high-temperature lifespan, and thus can successfully pass the “85° C./85% RH” aging test. Additionally, the capacitors have a short activation time and high carbon yield.

To achieve the above object, the present disclosure adopts the following technical solutions:

The present disclosure provides a method for preparing a water vapor-modified chemically-derived capacitive carbon, including:
(1) using a non-high-temperature-calcined activated carbon, namely, an intermediate of a commercial chemically-derived capacitive carbon, as a base carbon, weighing and filling the base carbon into a corundum boat such that the base carbon is attached to a wall of the corundum boat with a space remaining in a middle part of the corundum boat, and leaving the corundum boat uncovered;
(2) placing the corundum boat filled with the non-high-temperature-calcined activated carbon in a central zone of a tubular furnace, inserting an end cap to seal the tubular furnace, introducing a nitrogen flow into the tubular furnace, heating to 250° C. at a heating rate of 10° C./min to 15° C./min, stopping the nitrogen flow, introducing water vapor at a flow rate of 0.15 L/min to 0.35 L/min, continuing heating to a temperature of 850° C. to 950° C. at the heating rate of 10° C./min to 15° C./min, and holding at the temperature of 850° C. to 950° C. for 30 min to 60 min; and
(3) naturally cooling to 750° C., switching the water vapor to a nitrogen, continuing cooling to room temperature, taking out a resulting product to obtain the water vapor-modified chemically-derived capacitive carbon.

In the present disclosure, the capacitive carbon refers to an activated carbon for supercapacitor.

In some embodiments, the non-high-temperature-calcined activated carbon, namely, the intermediate of the commercial chemically-derived capacitive carbon, is prepared by activating a carbon material with potassium hydroxide.

In some embodiments, the carbon material includes one selected from the group consisting of petroleum coke, coconut shell carbide, walnut shell, phenolic resin, lignin, and asphalt.

Another objective of the present disclosure is to provide a process for manufacturing a capacitor, including: mixing the water vapor-modified chemically-derived capacitive carbon, a carbon black and a 60% polytetrafluoroethylene (PTFE) emulsion to obtain a carbon slurry; applying the carbon slurry onto an aluminum foil of a coating machine, and molding to obtain a double-sided electrode; drying, roll-pressing and compacting the double-sided electrode; cutting a resulting compacted double-sided electrode into electrode strips with a specific width using a cutting machine; winding the electrode strips onto a core of a winder, placing the carbon electrode strips into a casing, and subjecting a resulting casing to vacuum drying; using 1 M Et₄NBF₄/AN as an electrolyte, injecting the electrolyte into a glove box filled with an argon; and subjecting a resulting system to welding and aging in sequence to obtain a 10 F cylindrical capacitor.

In some embodiments, a mass ratio of the modified chemically-derived capacitive carbon, the carbon black, and the 60% PTFE emulsion is 8.4:1:0.6.

It can be seen from the above technical solutions that compared with the prior art, some embodiments of the present disclosure have the following beneficial effects:

(1) the Method for Preparing the Water Vapor-Modified Chemically-Derived Capacitive Carbon of the Present Disclosure does not Introduce Additional Process Steps:

The method for preparing the water vapor-modified chemically-derived capacitive carbon is essentially the same as the method for preparing the chemically-derived capacitive carbon. The method for preparing the water vapor-modified chemically-derived capacitive carbon only changes the last step for preparing the chemically-derived capacitive carbon process by replacing the introduction of nitrogen with water vapor in a box furnace, and changing a calcination temperature of ≤800° C. to a water vapor modification temperature of 850° C. to 950° C. No additional process steps or equipment are added, and the method is simple.

### (2) The Method for Preparing the Water Vapor-Modified Chemically-Derived Capacitive Carbon of the Present Disclosure Improves Work Efficiency:

Currently, for the activated carbon companies producing commercial capacitive carbon via the chemical method, the activation time from when the activated material enters the activation furnace until it is discharged after activation is 4 h to 8 h. Adding the water vapor modification time of 4 h to 8 h, the total time is 8 h to 16 h. However, using solely water vapor activation requires a total residence time of the activated material in the activation furnace of 60 h to 80 h, and necessitates a two-stage activation process. The first activation lasts for 10 h to 20 h, after which the material is cooled and then reloaded for a second activation lasting for 50 h to 60 h. Calculating based on the longest activation times for both methods, the activation time of the method of the water vapor-modified chemically-derived capacitive carbon is 64 hours shorter than that of the physical method. Therefore, the method of the water vapor-modified chemically-derived capacitive carbon is faster and more efficient.

### (3) the Method for Preparing the Water Vapor-Modified Chemically-Derived Capacitive Carbon of the Present Disclosure Increases the Carbon Yield and Reduces Cost:

Currently, the commercial capacitive carbon produced by the chemical method in activated carbon companies has a carbon yield of 70%, and the chemical carbon after water vapor modification has a carbon yield of 65%, resulting in an overall total carbon yield of 45.5%. However, the capacitive carbon prepared by the water vapor method using coconut shell granular carbide as the carbon source has a carbon yield of 25%. The total carbon yield from the chemical carbon preparation and the chemical carbon undergone water vapor modification is 20.5% higher than that from the capacitive carbon prepared by the water vapor method. An increased carbon yield reduces the cost of capacitive carbon.

(4) the Method for Preparing the Water Vapor-Modified Chemically-Derived Capacitive Carbon of the Present Disclosure Alters the Properties of the Chemically-Derived Capacitive Carbon and Imparts the Characteristics of the Physically-Derived Capacitive Carbon:

After the water vapor modification, the carbon in the chemically-derived capacitive carbon undergoes a secondary activation at high temperature (900° C.) and in water vapor, leading to wider pore radius, reduced surface functional groups, decreased viscosity, and accelerated dispersion and adsorption rate.

(5) For the method for preparing the water vapor-modified chemically-derived capacitive carbon of the present disclosure, the methylene blue adsorption capacity, iodine value, and packing density of the chemical petroleum coke-based commercial capacitive carbon modified by the water vapor are 24% higher, 23.5% higher, and 12.5% higher, respectively, than those of the current highest-quality physically-derived capacitive carbon, Japan's YP-50. The methylene blue adsorption capacity, iodine value, and packing density of the chemical coconut shell-based commercial capacitive carbon modified by the water vapor are 24% higher, 46.2% higher, and up to 7.5% higher, respectively, than those of Japan's YP-50. The method of the water vapor-modified chemically-derived capacitive carbon does not directly increase the methylene blue adsorption capacity, iodine value, and packing density of the physically-derived capacitive carbon. However, the capacitive carbon prepared by this method has physical properties identical to those of the physically-derived capacitive carbon, and has even higher quality.
(6) Using the method for preparing the water vapor-modified chemically-derived capacitive carbon of the present disclosure, the capacitive carbon prepared and commercial chemically-derived capacitive carbon are assembled into two sets of cylindrical 2.7 V 10 F capacitors, respectively. A 1 M Et₄NBF₄/AN solution is used as the electrolyte, and an 85° C. aging test is conducted. During the high-temperature aging test, the chemically-derived capacitive carbon has exhibited high initial capacitance. However, with the increase in the number of charge-discharge cycles and the extension of the time, the internal resistance increases rapidly and the capacity decays quickly. After aging for 1,000 h, the internal resistance change rate and capacity decay rate exceed 300% and 20%, respectively. However, for the water vapor-modified chemically-derived capacitive carbon, the internal resistance change rate and capacity decay rate are less than 300% and 20%, respectively. The aging test demonstrates that capacitors prepared from the modified chemically-derived capacitive carbon exhibit desirable electrochemical stability in extreme environments and possess the same capacity as that of commercial chemically-derived capacitive carbon.

### BRIEF DESCRIPTION OF THE DRAWINGS

To describe the technical solutions in the examples of the present disclosure or in the prior art more clearly, the drawings required for describing the examples or the prior art will be briefly described below. Apparently, the drawings in the following description merely show the of the present disclosure, and those of ordinary skill in the art can still derive other drawings from the provided drawings without creative efforts.

FIG. 1 shows the internal resistance change rate of the 2.7 V 10 F capacitors assembled with various capacitive carbons during 1,000-h aging at +85° C.

FIG. 2 shows the capacitance change rate of the 2.7 V 10 F capacitors assembled with various capacitive carbons during 1,000-h aging at +85° C.

FIG. 3 shows the pore size distribution of the chemically-derived capacitive carbon obtained from petroleum coke-based activated carbon by high-temperature water vapor modification and high-temperature nitrogen calcination.

FIG. 4 shows the pore size distribution of the chemically-derived capacitive carbon obtained from coconut shell-based activated carbon by high-temperature water vapor modification and high-temperature nitrogen calcination.

### DETAILED DESCRIPTION OF THE EMBODIMENTS

The technical solutions of the examples of the present disclosure are clearly and completely described below with reference to the drawings in the examples of the present disclosure. Apparently, the described examples are merely a part rather than all of the embodiments of the present disclosure. All other examples obtained by those skilled in the art based on the examples of the present disclosure, without creative efforts, shall fall within the scope of the present disclosure.

### Example 1

A non-high-temperature-calcined activated carbon, namely, an intermediate of a current commercial capacitive carbon, was used as a base carbon (the intermediate was prepared according to the specific preparation method in Comparative Example 1), with an average particle size D50 of 8 μm, 40 g of the base carbon was weighed and evenly filled into two corundum boats. The base carbon was attached to a wall of each of the corundum boats, with spaces left in the middle parts of the boats, and the corundum boats were left uncovered.

The two corundum boats filled with the base carbon were placed in a tubular furnace. The tubular furnace was sealed, purged with nitrogen, and heated to 250° C. at a heating rate of 12° C./min. Then the nitrogen was switched to water vapor with a flow rate of 0.3 L/min. The tubular furnace was further heated to 950° C. at the same heating rate, and held at 950° C. for 50 min, and then naturally cooled to 750° C. The atmosphere was then switched to nitrogen. The tubular furnace was allowed to continue cooling to room temperature. A resulting product was taken out to obtain a modified chemically-derived capacitive carbon. Following this procedure, 350 g of the modified chemically-derived capacitive carbon was prepared and mixed.

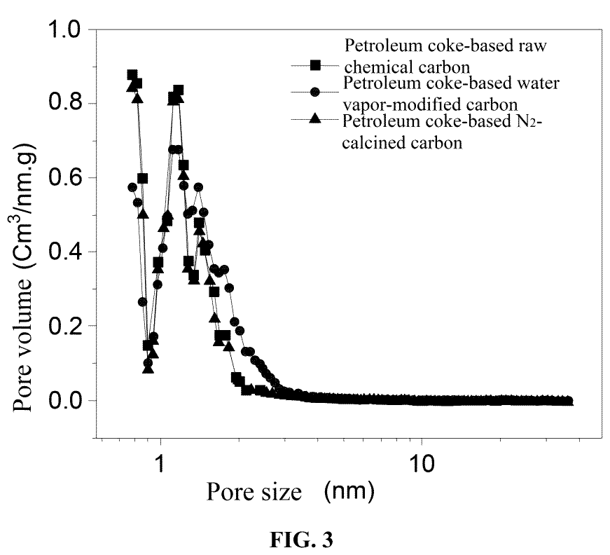

0.1 g of the modified chemically-derived capacitive carbon was used, its adsorption capacity was tested with a 0.15% methylene blue solution, showing a value of 31 mL, an iodine value of 2,002 mg/g, a packing density of 0.45 g/mL, a specific surface area of 1,917.9 m²/g, a total pore volume of 0.9 cm³/g, a micropore surface area of 1,695.798 m²/g, a micropore volume of 0.71 cm³/g, and an average pore size of 1.879 nm. These data are shown in Table 1. The nitrogen, hydrogen, oxygen, and carbon contents of the capacitive carbon were analyzed by an elemental analyzer, being 0.26%, 0.36%, 0.31%, and 98.82%, respectively. These data are shown in Table 2, and the pore size distribution is shown in FIG. 3.

Following the above steps, 350 g of modified chemically-derived capacitive carbon was prepared and used to fabricate a 2.7 V 10 F cylindrical capacitor:

(1) The modified chemically-derived capacitive carbon, an acetylene black, and a 60% PTFE emulsion were mixed at a mass ratio of 8.4:1:0.6. Water was added thereto, and a resulting mixture was added in a slurry machine to mix and obtain a carbon slurry.

(2) The carbon slurry was applied onto an aluminum foil using a coating machine and molded, obtaining a 500 mm wide double-sided carbon electrode cloth.

(3) The double-sided carbon electrode cloth was dried in an 80° C. vacuum dryer.

(4) A dried electrode cloth was compacted by a roller press to obtain an electrode cloth with a thickness of 230 μm.

(5) The electrode cloth was cut into electrode strips with a specific width using a cutting machine.

(6) The carbon electrode strips were wound onto a core of a winder.

(7) 1 M Et₄NBF₄/AN was used as an electrolyte, and injected into a resulting wound electrode core in a glove box filled with high-purity argon. Then the glove box was housed in a casing and sealed.

(8) A resulting system was subjected to steps such as vacuum drying, welding, and aging in sequence to obtain a cylindrical capacitor.

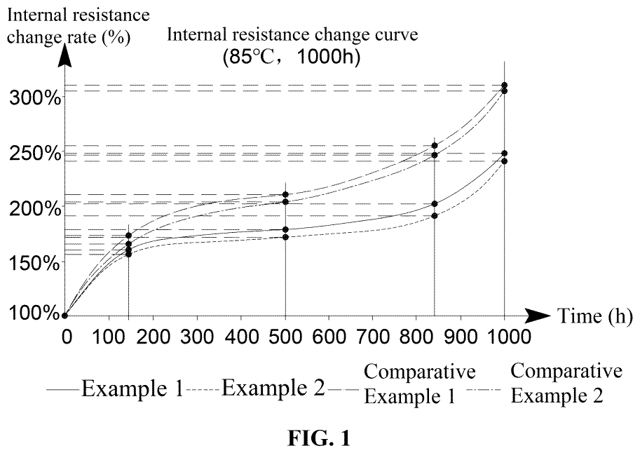

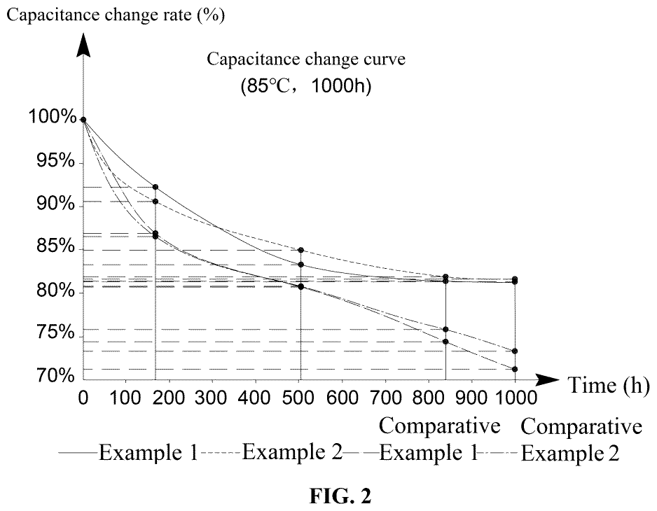

The supercapacitor fabricated from the modified capacitive carbon underwent a 1,000-h aging test at a high temperature of 85° C. The final test data were: capacitance 8.28 F, capacitance change rate 18.8%, internal resistance 118.5Ω, internal resistance change rate 248.4%, as detailed in Table 3 and shown in FIG. 1 and FIG. 2.

### Example 2

A non-high-temperature-calcined activated carbon, namely, an intermediate of a current commercial capacitive carbon, was used as a base carbon (the intermediate was prepared according to the specific preparation method in Comparative Example 2), 40 g of the base carbon was weighed and evenly filled into two corundum boats. The base carbon was attached toa wall of each of the corundum boats, with spaces left in the middle parts of the boats, and the corundum boats were left uncovered.

The two corundum boats filled with the base carbon were placed in a tubular furnace. The tubular furnace was sealed, purged with nitrogen, and heated to 250° C. at a heating rate of 10° C./min. Then the nitrogen was switched to water vapor with a flow rate of 0.35 L/min. The tubular furnace was further heated to 900° C. at the same heating rate, and held at 900° C. for 40 min, and then naturally cooled to 750° C. The atmosphere was then switched to nitrogen. The tubular furnace was allowed to continue cooling to room temperature. A resulting product was taken out to obtain a modified chemically-derived capacitive carbon. Following this procedure, 350 g of the modified chemically-derived capacitive carbon was prepared and mixed.

350 g of the modified chemically-derived capacitive carbon was mixed and tested, showing a methylene blue adsorption capacity of 31 mL, an iodine value of 2,312 mg/g, a packing density of 0.43 g/mL, a specific surface area of 2,142 m²/g, a total pore volume of 0.9779 m³/g, a micropore surface area of 1,916.85 m²/g, a micropore volume of 0.789 m³/g, and an average pore size of 1.825 nm. These data are shown in Table 1. The nitrogen, hydrogen, oxygen, and carbon contents of the capacitive carbon were analyzed by an elemental analyzer, being 0.28%, 0.4%, 0.28%, and 98.84%, respectively. These data are shown in Table 2.

Following the method for preparing the capacitor described in Example 1, the modified chemically-derived capacitive carbon from this example was used to fabricate a 2.7 V 10 F cylindrical capacitor. It underwent a 1,000-h aging test at a high temperature of 85° C. The final test data were: capacitance 8.24 F, capacitance change rate 18.4%; internal resistance 106Ω, internal resistance change rate 224.5%. These data are detailed in Table 3 and shown in FIG. 1 and FIG. 2.

### Comparative Example 1

A method for producing a current chemically-derived petroleum coke-based commercial capacitive carbon at a certain company, as referenced in Example 1, was as follows:

(1) A petroleum coke was used as a carbon material and ground into powder. Potassium hydroxide was used as an activator.

(2) Material ratio was set to 1:2.

(3) Dehydration: the petroleum coke powder and potassium hydroxide were poured into a reactor, respectively. A resulting mixture was heated to melt, stirred, dehydrated, and degassed until solidified at 400° C. After slight cooling, a cooled mixture was transferred to an activation tank.

(4) Activation: the activation tank was placed into an activation furnace. A power was turned on. The activation furnace was heated, and a nitrogen flow was introduced into the activation furnace. The activation furnace was heated to 780° C. in 50 min, and held at 780° C. for 4 h. When the temperature decreased to 400° C., the nitrogen flow was stopped, and a resulting product was immediately discharged from the activation furnace and sprinkled with water.

(5) Post-treatment: a sprinkled product underwent alkali recovery, boiling with hydrochloric acid, acid washing, water washing until a pH value reached 6, and drying to obtain a non-calcined capacitive carbon.

(6) Testing: methylene blue adsorption capacity was 36 mL, iodine adsorption value was 2,478 mg/g, density was 0.44 g/mL, specific surface area was 2,052 m²/g, total pore volume was 0.89 cm³/g, micropore surface area was 1,891.78 m²/g, micropore volume was 0.75 cm³/g, and average pore size was 1.742 nm. These data are shown in Table 1.

(7) Calcination: a dried non-calcined capacitive carbon was loaded into a graphite crucible and placed into a calcination furnace. A power was turned on. The calcination furnace was heated, and a nitrogen flow was introduced into the calcination furnace. The calcination furnace was heated to 760° C. in 50 min, and held at 760° C. for 2 h. When the temperature decreased to room temperature, the nitrogen flow was stopped, and a resulting product was discharged from the calcination furnace.

(8) The product was poured into a mixer, nitrogen gas was introduced into the mixer, and a power was turned on. The product was rotated and mixed at 60 rpm for 30 min. A resulting sample was taken for testing. A resulting carbon powder was suctioned and bagged to obtain a commercial capacitive carbon.

(9) Testing: methylene blue adsorption capacity was 33 mL, iodine adsorption value was 2,016 mg/g, density was 0.46 g/mL, specific surface area was 1,952.24 m²/g, pore volume was 0.804 cm³/g, micropore surface area was 1,822.375 m²/g, micropore volume was 0.726 cm³/g, and average pore size was 1.722 nm. These data are shown in Table 1. The nitrogen, hydrogen, oxygen, and carbon contents of the chemically-derived capacitive carbon analyzed by an elemental analyzer were 0.63%, 0.27%, 0.33%, and 98.3%, respectively. These data are shown in Table 2. Its pore size distribution is shown in FIG. 3.

350 g of this commercial capacitive carbon was taken and used to fabricate a 2.7 V 10 F cylindrical capacitor following the preparation method described in Example 1. The resulting capacitor showed a capacitance of 8.62 F and a capacitance change rate of 28.7%; an internal resistance of 164.5Ω and an internal resistance change rate of 310.3%. These data are detailed in Table 3 and shown in FIG. 1 and FIG. 2.

### Comparative Example 2

A method for producing a current chemically-derived coconut shell-based commercial capacitive carbon at a certain company, as referenced in Example 2, was as follows:

(1) A coconut shell carbide was used as a carbon material and ground into powder. Potassium hydroxide was used as an activator.

(2) Material ratio was set to 1:1.9.

(3) Dehydration: the coconut shell carbide powder and potassium hydroxide were poured into a reactor, respectively. A resulting mixture was heated to melt, stirred, dehydrated, and degassed until solidified at 400° C. After slight cooling, a cooled mixture was transferred to an activation tank.

(4) Activation: the activation tank was placed into an activation furnace. A power was turned on. The activation furnace was heated, and a nitrogen flow was introduced into the activation furnace. The activation furnace was heated to 780° C. in 50 min, and held at 780° C. for 4 h. When the temperature decreased to 400° C., the nitrogen flow was stopped, and a resulting product was immediately discharged from the activation furnace and sprinkled with water.

(5) Post-treatment: a sprinkled product underwent alkali recovery, boiling with hydrochloric acid, acid washing, water washing until a pH value reached 6, and drying to obtain a non-calcined capacitive carbon.

(6) Testing: methylene blue adsorption capacity was 32.5 mL, iodine adsorption value was 2,010 mg/g, density was 0.46 g/mL, specific surface area was 1,866.268 m²/g, total pore volume was 0.8116 m³/g, micropore surface area was 1,731.84 m²/g, micropore volume was 0.692 m³/g, and average pore size was 1.74 nm. These data are shown in Table 1.

(7) Calcination: a dried non-calcined capacitive carbon was loaded into a graphite crucible and placed into a calcination furnace. A power was turned on. The calcination furnace was heated, and a nitrogen flow was introduced into the calcination furnace. The calcination furnace was heated to 760° C. in 50 min, and held at 760° C. for 2 h. When the temperature decreased to room temperature, the nitrogen flow was stopped, and a resulting product was discharged from the calcination furnace.

(8) The product was poured into a mixer, nitrogen gas was introduced into the mixer, and a power was turned on. The product was rotated and mixed at 60 rpm for 30 min. A resulting samples were taken for testing. A resulting carbon powder was suctioned and bagged, air-exhausted to obtain a commercial capacitive carbon.

(9) Testing: methylene blue adsorption capacity was 31 mL, iodine adsorption value was 2,294 mg/g, density was 0.49 g/mL, specific surface area was 1,931.338 m²/g, total pore volume was 0.8425 m³/g, micropore surface area was 1,801.861 m²/g, micropore volume was 0.724 m³/g, and average pore size was 1.745 nm. These data are shown in Table 1.

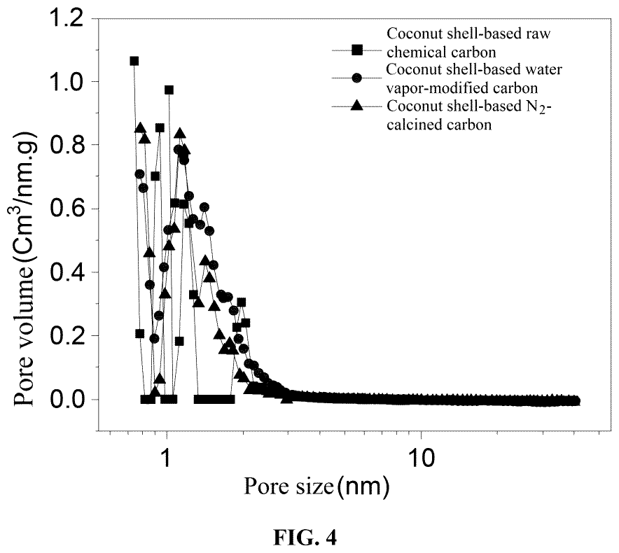

The nitrogen, hydrogen, oxygen, and carbon contents of the commercial capacitive carbon analyzed by an elemental analyzer were 0.54%, 0.19%, 0.3%, and 98.64%, respectively. These data are shown in Table 2, and the pore size distribution is shown in FIG. 4.

350 g of this commercial capacitive carbon was taken and used to fabricate a 2.7 V 10 F cylindrical capacitor following the preparation method described in Example 1. The resulting capacitor showed a capacitance of 7.48 F and a capacitance change rate of 25.9%; an internal resistance of 159.7Ω and an internal resistance change rate of 305.4%. These data are detailed in Table 3 and shown in FIG. 1 and FIG. 2.

### Comparative Example 3

Japanese YP-50, a water vapor physically-derived capacitive carbon, was selected.

Testing shows a methylene blue adsorption capacity of 25 mL, iodine adsorption value of 1,621 mg/g, density of 0.4 g/mL, specific surface area of 1,586 m²/g, average pore size of 1.87 nm, and pore volume of 0.741 cm³/g. The test data are shown in Table 1.

350 g of the YP-50 capacitive carbon was taken and used to prepare a 2.7 V 10 F cylindrical capacitor following the preparation method described in Example 1. A resulting capacitor had a capacitance of 6.63 F and a capacitance change rate of 18.2%; an internal resistance of 99Ω and an internal resistance change rate of 223.6%. These data are shown in Table 3.

TABLE 1
Physical test data of the capacitive carbons prepared under different conditions

| | Methylene | | | | | | | |
|---|---|---|---|---|---|---|---|---|
| | blue | | | Total | Total | | | Average |
| | adsorption | Iodine | | pore | pore | Micropore | Micropore | pore |
| | capacity | value | Density | area | volume | area | volume | size |
| Name | (mL) | (mg/g) | (g/mL) | (m²/g) | (m³/g) | (m²/g) | (m³/g) | (nm) |
| Example 1 | 31 | 2002 | 0.45 | 1917.9 | 0.9 | 1695.798 | 0.71 | 1.879 |
| Example 2 | 31 | 2312 | 0.43 | 2142.848 | 0.9779 | 1916.85 | 0.789 | 1.825 |
| Comparative | 33 | 2016 | 0.46 | 1952.24 | 0.804 | 1822.375 | 0.726 | 1.722 |
| Example 1 | | | | | | | | |
| Comparative | 31 | 2294 | 0.49 | 1931.338 | 0.8425 | 1801.861 | 0.724 | 1.745 |
| Example 2 | | | | | | | | |
| Comparative | 25 | 1621 | 0.4 | 1586 | 0.741 | | | 1.87 |
| Example YP- | | | | | | | | |
| 50 carbon | | | | | | | | |
| Petroleum | 36 | 2478 | 0.44 | 2052.2 | 0.89 | 1891.78 | 0.75 | 1.742 |
| coke-based | | | | | | | | |
| uncalcined | | | | | | | | |
| carbon | | | | | | | | |
| Coconut | 32.5 | 2010 | 0.46 | 1866.268 | 0.8116 | 1731.84 | 0.692 | 1.74 |
| shell-based | | | | | | | | |
| uncalcined | | | | | | | | |
| carbon | | | | | | | | |

In Table 1, the methylene blue adsorption capacity, iodine value, and specific surface area of the capacitive carbon obtained by high-temperature water vapor modification and high-temperature nitrogen calcination of the chemical petroleum coke-based activated carbon respectively in Example 1 and Comparative Example 1 are compared. The methylene blue adsorption capacity, iodine value and specific surface area of the capacitive carbon obtained by high-temperature water vapor modification are slightly lower, while the average pore size and pore volume are slightly higher than those of the capacitive carbon obtained by high-temperature nitrogen calcination.

The methylene blue adsorption capacity of the capacitive carbon obtained by high-temperature water vapor modification and high-temperature nitrogen calcination of the coconut shell-based activated carbon in Example 2 is equal compared with that in Example 2. However, in terms of surface area, iodine value, average pore size and pore volume, the capacitive carbon obtained by high-temperature water vapor modification is higher than that obtained by high-temperature nitrogen calcination.

The methylene blue adsorption capacity, iodine value, specific surface area, pore size and pore volume of the capacitive carbon obtained by high-temperature water vapor modification of both chemical petroleum coke-based activated carbon and chemical coconut shell-based activated carbon are significantly higher than those of YP-50 coconut shell-based water vapor physical carbon.

The increase in pore size and pore volume accelerates the adsorption rate of the capacitive carbon, improves the conductivity and the rate of ion movement in and out of the electrolyte, thereby increasing the stability of the capacitor. The improvement in methylene blue adsorption capacity, iodine value, and specific surface area contributes to an increase in specific capacitance.

TABLE 2
Data on the nitrogen, hydrogen, oxygen, and carbon
contents in the capacitive carbon of each example

| Name | Nitrogen | Hydrogen | Oxygen | Carbon |
|---|---|---|---|---|
| Example 1 | 0.26 | 0.36 | 0.31 | 98.82 |
| Example 2 | 0.28 | 0.4 | 0.28 | 98.84 |
| Comparative | 0.63 | 0.27 | 0.33 | 98.3 |
| Example 1 | | | | |
| Comparative | 0.54 | 0.19 | 0.3 | 98.64 |
| Example 2 | | | | |

As shown in Table 2, the nitrogen, hydrogen, oxygen, and carbon contents data in the capacitive carbon of each example suggest that: the nitrogen and oxygen contents in the examples are lower than those in the comparative examples, respectively, while the carbon content in the examples is higher than that in the comparative examples. The lower the nitrogen and oxygen contents and the higher the carbon content in the capacitive carbon, the lower the internal resistance change rate and the lower capacitance change rate in assembled capacitors.

TABLE 3
Aging test data of 2.7 V 10 F capacitors assembled from various
capacitive carbons at +85° C. for 1,000 h

| | | Example | Example | Comparative | Comparative | Japan |
|---|---|---|---|---|---|---|
| Name | | 1 | 2 | Example 1 | Example 2 | YP-50 |
| 0 h | Capacitance | 10.2 | 10.1 | 12.1 | 10.2 | 8.1 |
| | Internal resistance | 34 | 31.2 | 40.1 | 39.4 | 30.6 |
| 168 h | Capacitance | 9.4 | 9.14 | 10.5 | 8.83 | 7.5 |
| | Capacitance | 7.84 | 9.5 | 13.22 | 13.43 | 7.41 |
| | change rate | | | | | |
| | Internal resistance | 54.4 | 48.9 | 69.9 | 65.2 | 45.3 |
| | Internal resistance | 160 | 156.7 | 174.3 | 165.5 | 148 |
| | change rate | | | | | |
| 504 h | Capacitance | 8.5 | 8.6 | 9.75 | 8.24 | 7 |
| | Capacitance | 16.67 | 14.85 | 19.42 | 18.4 | 13.58 |
| | change rate | | | | | |
| | Internal resistance | 60.69 | 53.7 | 84.4 | 80.2 | 51.4 |
| | Internal resistance | 178.5 | 172.2 | 210.4 | 203.6 | 168 |
| | change rate | | | | | |
| 840 h | Capacitance | 8.3 | 8.26 | 9 | 7.73 | 6.65 |
| | Capacitance | 18.6 | 18.2 | 25.6 | 24.2 | 17.9 |
| | change rate | | | | | |
| | Internal resistance | 68.62 | 59.5 | 102.3 | 97.2 | 56.5 |
| | Internal resistance | 201.8 | 190.7 | 255.2 | 246.6 | 184.5 |
| | change rate | | | | | |
| 1000 h | Capacitance | 8.28 | 8.24 | 8.62 | 7.48 | 6.63 |
| | Capacitance | 18.8 | 18.4 | 28.8 | 26.7 | 18.1 |
| | change rate | | | | | |
| | Internal resistance | 84.49 | 75.5 | 124.4 | 120.4 | 68.4 |
| | Internal resistance | 248.5 | 241.9 | 310.3 | 305.6 | 223.5 |
| | change rate | | | | | |

In Table 3, the capacitance change rate and internal resistance change rate of the capacitors assembled from the water vapor-modified chemically-derived capacitive carbon of Examples 1 to 2 and the Japan YP-50 physically-derived capacitive carbon are all below 20% and 300%, respectively, passing the high-temperature +85° C. 1,000-h aging test. However, the capacitance change rate and internal resistance change rate of the capacitors assembled from the commercial chemically-derived capacitive carbon of Comparative Examples 1 to 2 both exceed 20% and 300%, respectively, failing the high-temperature +85° C. 1,000-h aging test. The aging test demonstrates that the high-temperature water vapor activation of the chemical carbon alters its properties, and the properties of physical carbon are attributed to chemical carbon.

Furthermore, the specific capacitance of the modified capacitive carbon is 20% higher than that of the Japan YP-50 physically-derived capacitive carbon, slightly lower than that of the petroleum coke-based chemically-derived capacitive carbon, and 9.7% higher than that of the coconut shell-based chemically-derived capacitive carbon. This addresses the issue of low capacitance of the capacitors assembled with physically-derived capacitive carbons, while simultaneously addressing the issues of rapid capacity decay and short lifespan of capacitors assembled with chemically-derived capacitive carbon in high-temperature extreme environments, thereby expanding the application range of double electric layer capacitors.

In Table 3, the examples and comparative examples are capacitive carbons prepared from petroleum coke and coconut shell as a carbon material and modified by water vapor. The modified capacitive carbons already exhibit the characteristics of physically-derived capacitive carbon, and the stability of the capacitors assembled from this modified capacitive carbon is significantly improved. Water vapor modification is not limited to activated carbon prepared from petroleum coke and coconut shell as a carbon material. This method is also applicable to the water vapor modification of chemically activated carbon prepared from other carbon materials. The applicant of the present disclosure uses this method to assemble the capacitive carbons prepared from activated carbon and modified by water vapor into capacitors, where the activated carbon is prepared from lignin, asphalt, and thermosetting phenolic resin as a carbon material. The electrochemical performance of the capacitors is identical to that of the capacitors assembled from the capacitive carbons prepared from activated carbon and modified by water vapor, where the activated carbon is prepared from petroleum coke and coconut shell as a carbon material.

As shown in FIG. 3 and FIG. 4: The pore size distribution curve peaks of chemically-derived petroleum coke-based carbon, coconut shell-based carbon, and their calcined carbon under nitrogen protection at 760° C. are mostly near 1 nm, indicating a high proportion of micropores. The pore size curve of the capacitive carbon modified by high-temperature water vapor shifts to the right, moving in the direction of pore size increase. The micropores of the original carbon (chemically-derived petroleum coke-based and coconut shell-based carbon) had been widened, the pore radius has increased, and the average pore size has increased from 1.8 nm. The widened pores could facilitate charge transfer, improve conductivity, reduce internal resistance, enhance the pore structure of the activated carbon, increase capacitor stability, and extend capacitor lifespan.

Each example of the present specification is described in a progressive manner, each example focuses on the difference from other examples, and the same and similar parts between the examples may refer to each other. As for the device disclosed in the examples, since the device corresponds to the method disclosed in the examples, the description is relatively simple, and reference may be made to the partial description of the method for relevant contents.

The above description of the disclosed embodiments enables those skilled in the art to achieve or use the present disclosure. Various modifications to these embodiments are readily apparent to those skilled in the art, and the generic principles defined herein may be practiced in other embodiments without departing from the spirit or scope of the present disclosure. Thus, the present disclosure is not limited to the examples shown herein but falls within the widest scope consistent with the principles and novel features disclosed herein.

What is claimed is:

1. A method for preparing a water vapor-modified chemically-derived capacitive carbon, comprising:
(1) using a non-high-temperature-calcined activated carbon, namely, an intermediate of a commercial chemically-derived capacitive carbon, as a base carbon, weighing and filling the base carbon into a corundum boat such that the base carbon is attached to a wall of the corundum boat with a space remaining in a middle part of the corundum boat, and leaving the corundum boat uncovered;
(2) placing the corundum boat filled with the non-high-temperature-calcined activated carbon in a central zone of a tubular furnace, inserting an end cap to seal the tubular furnace, introducing a nitrogen flow into the tubular furnace, heating to 250° C. at a heating rate of 10° C./min to 15° C./min, stopping the nitrogen flow, introducing water vapor at a flow rate of 0.15 L/min to 0.35 L/min, continuing heating to a temperature of 850° C. to 950° C. at the heating rate of 10° C./min to 15° C./min, and holding at the temperature of 850° C. to 950° C. for 30 min (minutes) to 60 min; and
(3) naturally cooling to 750° C., switching the water vapor to a nitrogen, continuing cooling to room temperature, taking out a resulting product to obtain the water vapor-modified chemically-derived capacitive carbon.

2. The method of claim 1, wherein the non-high-temperature-calcined activated carbon, namely, the intermediate of the commercial chemically-derived capacitive carbon, is prepared by activating a carbon material with potassium hydroxide.

3. The method of claim 2, wherein the carbon material comprises one selected from the group consisting of petroleum coke, coconut shell carbide, walnut shell, phenolic resin, lignin, and asphalt.

4. A water vapor-modified chemically-derived capacitive carbon prepared by the method of claim 1.

5. A process for manufacturing a capacitor, comprising: mixing the water vapor-modified chemically-derived capacitive carbon of claim 4, a carbon black and a 60% polytetrafluoroethylene (PTFE) emulsion to obtain a carbon slurry; applying the carbon slurry onto an aluminum foil of a coating machine, and molding to obtain a double-sided electrode; drying, roll-pressing and compacting the double-sided electrode; cutting a resulting compacted double-sided electrode into electrode strips with a specific width using a cutting machine; winding the electrode strips onto a core of a winder, placing a resulting winded core of the winder into a casing, and subjecting a resulting system to vacuum drying; using 1 M Et₄NBF₄/AN as an electrolyte, injecting the electrolyte into a glove box filled with an argon; and subjecting a resulting system to welding and aging in sequence to obtain a 10 F cylindrical capacitor.

6. The process of claim 5, wherein a mass ratio of the modified chemically-derived capacitive carbon, the carbon black, and the 60% PTFE emulsion is 8.4:1:0.6.

7. The water vapor-modified chemically-derived capacitive carbon of claim 4, wherein the non-high-temperature-calcined activated carbon, namely, the intermediate of the commercial chemically-derived capacitive carbon, is prepared by activating a carbon material with potassium hydroxide.

8. The water vapor-modified chemically-derived capacitive carbon of claim 7, wherein the carbon material comprises one selected from the group consisting of petroleum coke, coconut shell carbide, walnut shell, phenolic resin, lignin, and asphalt.
